(19) United States
(12) Patent Application Publication
(10) Pub. No.: US 2002/0070969 A1
(43) Pub. Date: Jun. 13, 2002

(54) Method for customizing a computer program resident toolbar

(75) Inventors: Molly K. Barksdale, Austin, TX (US); Bethany L. Kessen, Apex, NC (US); Martin T. Moore, Durham, NC (US)

Correspondence Address: Frank C. Nicholas, CARDINAL LAW GROUP, 1603 Orrington Avenue, Suite 2000, Evanston, IL, 60201, US

(73) Assignee: International Business Machines Corporation

(21) Appl. No.: 09/732,254

(22) Filed: Dec. 7, 2000

(51) Int. Cl. G06F 3/00

(52) U.S. Cl. 345/765; 345/779

(57) ABSTRACT

A method for customizing a toolbar of a computer program is provided. In the method, at least one function from a list of at least one function is selected from the computer program. After selecting the desired function, a pointer is assigned to the function while the computer program remains operational in the foreground. The pointer is then positioned to a desired location on a secondary toolbar.

### BACKGROUND OF THE INVENTION

A client running a program within an operating system's graphical user interface receives distinct advantages over text based command lines. The client no longer has to memorize folder or file names and locations. The client is also freed of providing enormous and complex command lines, which are instead replaced by graphic pointers and addressed attributes known in the art. By merely looking at an icon or menu of folders and file names, the client has access to a much larger offering of computing services then could ever be memorized.

A key element to the usefulness of a GUI enhanced operating system, are the client friendly computer program GUI's they support. Computer program GUI's provide every client with program specific functionality previously accessible to only experienced program clients. Part of a computer program GUI's increased functionality resides in the use of “toolbars”. A toolbar is a horizontal or vertical strip with the appearance of containing icons, command names, file names, pull down menus, or similarly recognizable forms of functional representation known in the art. An element of usefulness of a toolbar is greatly enhanced if the computer program allows the client to customize the toolbar to contain the functionality used most often by the client. This reduces lost client time associated with repetitive movement and function searching, thus enhancing attentiveness and the overall performance of the client.

Current computer programs such as Microsoft Word, allow for toolbar customization by accessing a menu option and selecting “customize toolbar”. Selecting this option causes a pop up window to appear, requiring the client to check off the tools they want visible in different toolbars. This customization function however, requires the computer program's main function to halt. The main function is placing it in a wait state also known as background, allowing the client to proceed with the toolbar customization while the current toolbar configuration is inoperative. By placing the main function in background, the client cannot continue with the workflow that the customization is intended to enhance. Additionally, the current menu customizations are restricted to a selection of operations available from the hosting computer programs source code alone. Another limiting property of the current customization routines involves the toolbar functionality after the customization is complete. When a client chooses a toolbar operation, the operation can only be performed on an area or window of an object already chosen as active, thereby creating more unnecessary motion and repetition.

Thus, there is a need for a method of computer program toolbar customization that improves upon the existing art.

### FIELD OF THE INVENTION

The present invention generally relates to computer programs and more particularly, to an improved technique of customizing a graphical user interface (GUI) toolbar within a computer program.

### SUMMARY OF THE INVENTION

One aspect of the present invention provides a method for customizing a computer program resident toolbar. In the method of one embodiment, at least one function from a list of at least one function is selected from the computer program. After selecting the desired function, a pointer is assigned to the function while the computer program remains operational in the foreground. The pointer is then positioned to a desired location on a secondary toolbar.

Another aspect of the present invention provides a method for customizing a computer program resident toolbar by selecting at least one function available from the computer program. The function can already have a pointer assigned to it and the pointer is copied while the computer program remains fully operational. The copied pointer can then be repositioned to a desired location on the toolbar.

A further aspect of the present invention provides a computer program product in a computer usable medium. The computer program can have code for selecting at least one function available from the computer program. The computer program code can assign a pointer to the selected function while the computer program remains fully operational. Finally, the computer program code can position the pointer to a desired location on a toolbar.

Another aspect of the invention provides a computer program product in a computer usable medium. The computer program can have code for selecting at least one function available from the computer program. The computer program code can copy a pointer to the selected function, while the computer program remains fully operational. Last, the computer program code can position the copied pointer to a desired location on a toolbar.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a flow chart representation of one embodiment of a method performed by a computer program graphical user interface to select and capture a function in accordance with the present invention;

FIG. 2 is an illustration of the computer program graphical user interface of FIG. 1 in accordance with the present invention;

FIG. 3 is an illustration of a selected toolbar within the computer program graphical user interface of FIG. 2;

FIG. 4 is an illustration of a pull down menu within the toolbar selected in FIG. 3;

FIG. 5 is an illustration of a selected function within the pull down menu of FIG. 4;

FIG. 6 is an illustration initial capture of the selected function of FIG. 5;

FIG. 7 is a flow chart representation of one embodiment of the method performed by the computer program graphical user interface of FIG. 1 to duplicate and relocate the selected function of FIG. 5 in accordance with the present invention;

FIG. 8 is an illustration of the pull down menu of FIG. 3 closing, allowing full view of the graphical user interface of FIG. 2;

FIG. 9 is an illustration of the relocation to a toolbar of the selected function of FIG. 5; and

FIG. 10 is an illustration of one embodiment of a customized computer program toolbar in accordance with the present invention.

### DETAILED DESCRIPTION OF THE PRESENTLY PREFERRED EMBODIMENTS

One embodiment of the invention allows a client the flexibility to customize their toolbar “on the fly” without disrupting their workflow. This feature does not require the computer programs main function to be placed into background, a technique known in the art. For the purposes of this application, the main function can be taken to mean the principal application of a computer program, that hosts all other functions and features as dependants of the main function.

Another embodiment of the invention can allow for the customizing of toolbars without altering or suspending customer preference settings and prior art toolbar customization methods. This type of functional coexistence allows the client to use the method that they prefer. An additional embodiment of the present invention allows for the interpretation of pointers, source code, html, TCP/IP addressing, and other formats of accessing and processing executable functions from non-resident programs and operating systems, thus allowing cross platform application compatibility.

Also, one embodiment of the invention provides a toolbar customizing program with the functionality of a toolbar command by performing a requested function or service directly upon an object. This is done by click and dragging an icon or other graphic representation of a function within a computer program, and releasing the chosen function upon the object. The object may be a file, folder, address, program, or any other type known in the art, and need only be capable of using the function or service released over it. An example would be to click and drag a copy command icon over a text document in order to place the document on the GUI clipboard in a manner known in the art.

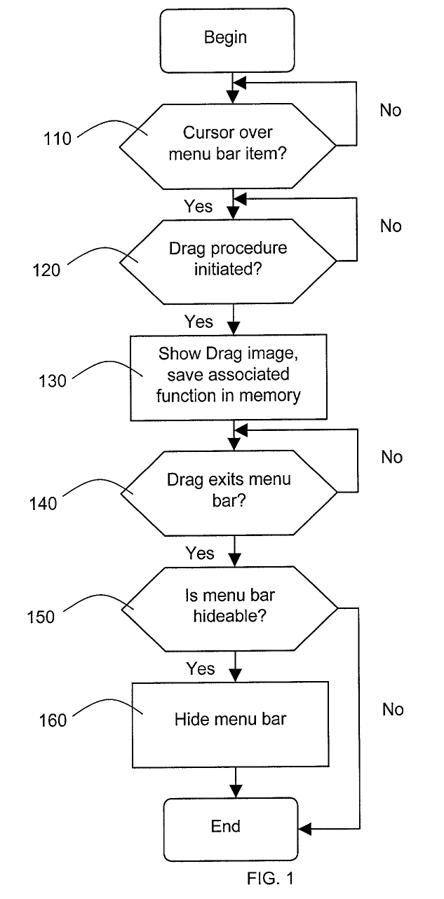

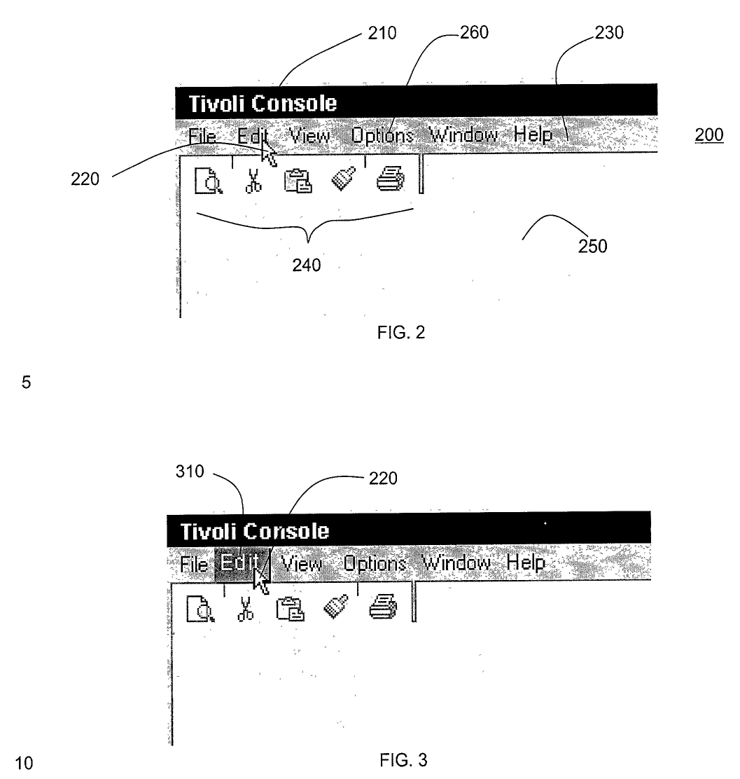

The following detailed description, beginning with the flowchart methodology of FIG. 1 and including the illustrations of FIG. 2 through FIG. 6, pertains to an embodiment of the invention associated with customizing a toolbar without disrupting workflow. Illustrated is a typical GUI 200 as is known in the art, comprised of a title bar 210 a menu toolbar 230, an icon toolbar 240, a work area (desktop) 250, and a pointing cursor 220. Each toolbar may be the host, recipient or both of a customizing function. Furthermore, a toolbar may contain the type “menu” 230, “pull down list” 260, “list”, “icon” 240, or other form or type known in the art. As referred to in Block 110, illustration 200 shows a cursor 220 that is being manipulated by a mouse, but any form of cursor control known to the art may be used. The cursor 220 can be manipulated to locate a toolbar containing a desired function by positioning the cursor over the toolbar, and as an example, in FIG. 3 the desired function is located by first moving the cursor 220 over EDIT 310.

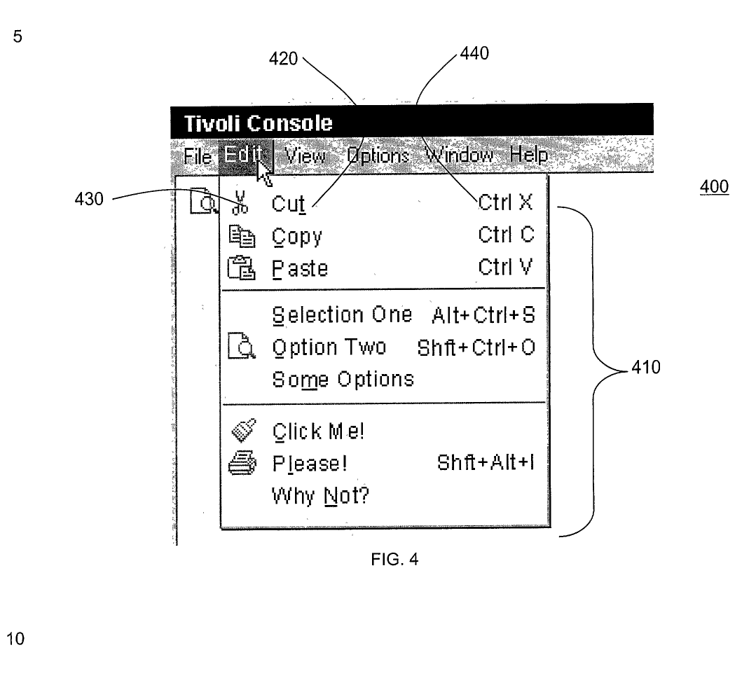

Upon moving to EDIT 310, the cursor 220 activates a pull down list feature of the toolbar 230 in a manner known in the art and shown in FIG. 4. The EDIT pull down list 410 is illustrated within the GUI view 400. The pull down list 410 can contain icons, function names, keystroke commands, or any other form of function representation known to the art. In one embodiment, all features of the pull down list 410 are associated with predefined individual functions of the main computer program. Illustrated within the features of pull down list 410 are the icon “scissors” 430, which is the graphic representation of the command “cut” 420. The “cut” command can also be accessed by the keystroke “control X” 440.

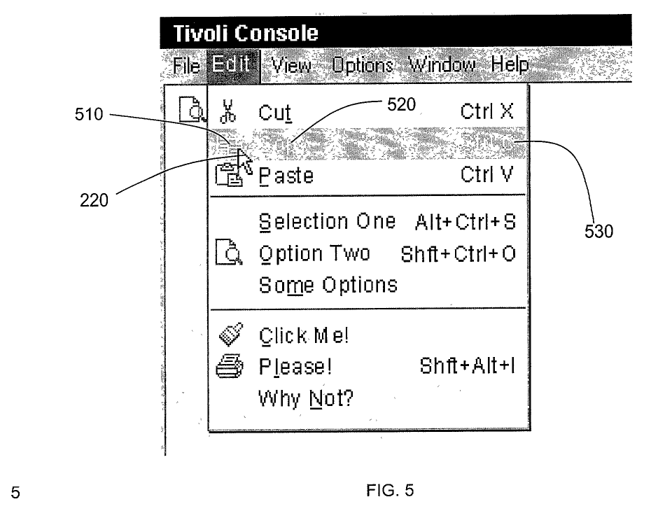

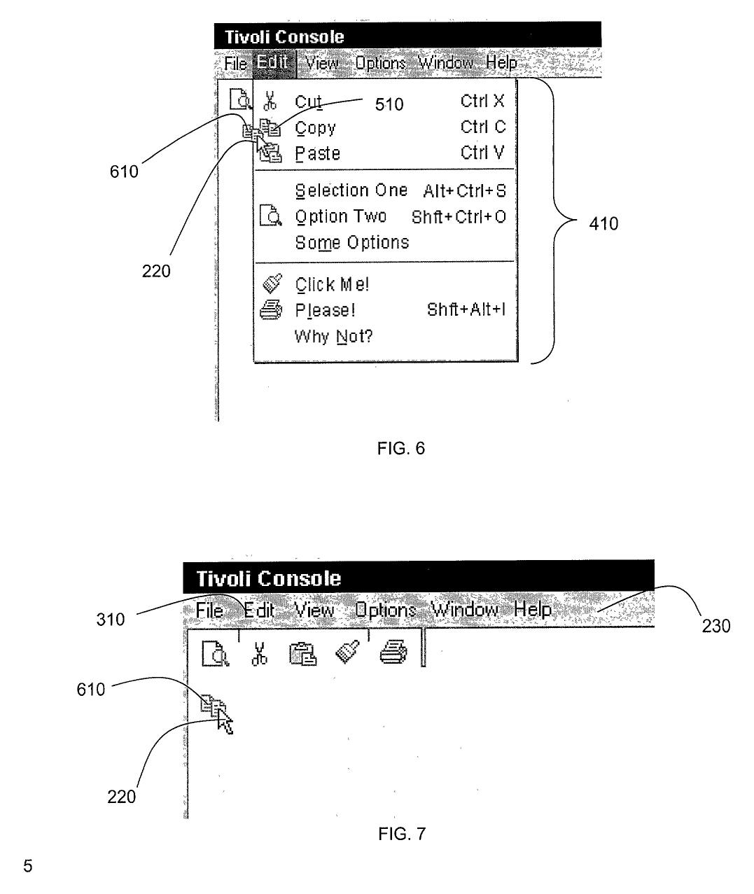

As demonstrated in FIG. 5, a client can move the cursor 220 over a function desired for another toolbar location, in this example the copy command icon 510. In one embodiment (Block 120), the chosen function can be obtained for relocation by a click hold and drag procedure known in the art, but alternative methods may be used. An additional embodiment allows that if the client had picked the function name “copy” 520 or the keystroke “Ctrl C” 530 instead of the double page icon 510, their appearance may be changed from their illustrated text, to the double page icon 510, as is illustrated by icon 610 in FIG. 6. In the embodiment of FIG. 6, the cursor 220 has chosen the double page icon 510 and is dragging its copy 610 off the pull down list 410. Block 130 further expresses that the function remain in memory while the copied icon 610 is being dragged, thus providing a one time use of the function upon any feature capable of receiving the desired functionality. An example would be to place the double page icon 510 upon a page of text as opposed to a toolbar, resulting in the page of text being copied in accordance with the original function in memory. An alternative embodiment can copy the function executable program as an attribute to the icon. Further, another embodiment can copy the location in permanent memory (address) of the function as an attribute to the icon.

Another embodiment of the invention allows the original menu to close after the cursor carrying an icon exits the host toolbar. This action provides for the entire work area to be accessible for the relocation of the icon. For example, as illustrated in FIG. 7, the double page icon 610 is carried by the cursor 220 and moves off its pull down list (Block 140). In this embodiment, because a pull down list is of a toolbar type that can and usually is hidden (Block 150), the pull down list is hidden or “closed” (Block 160) and the menu toolbar 230 displays only the EDIT menu 310.

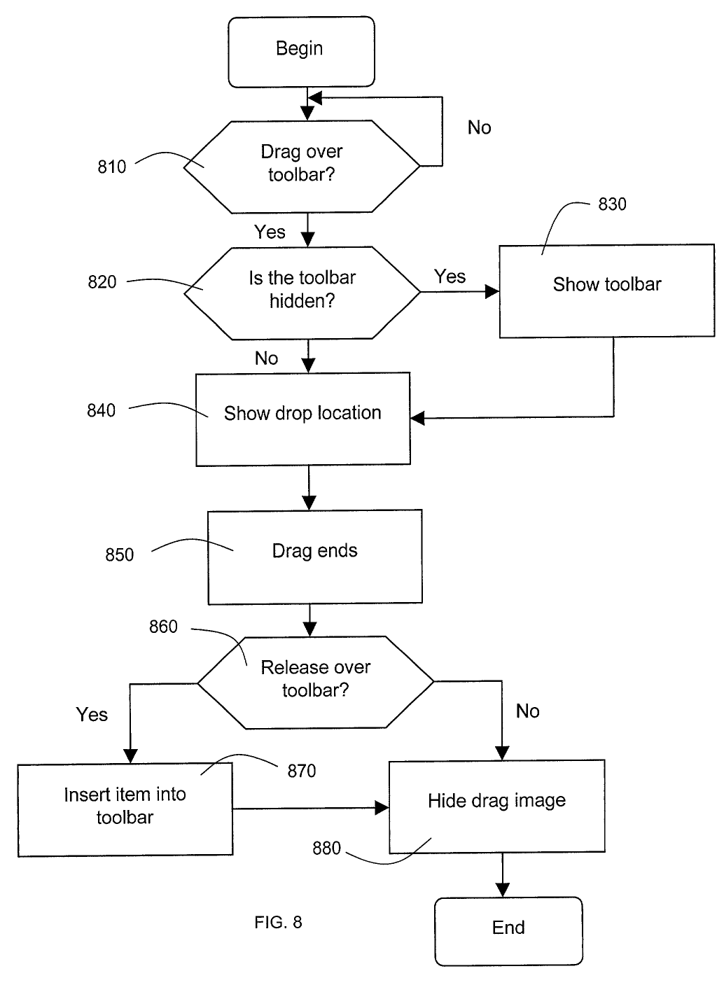

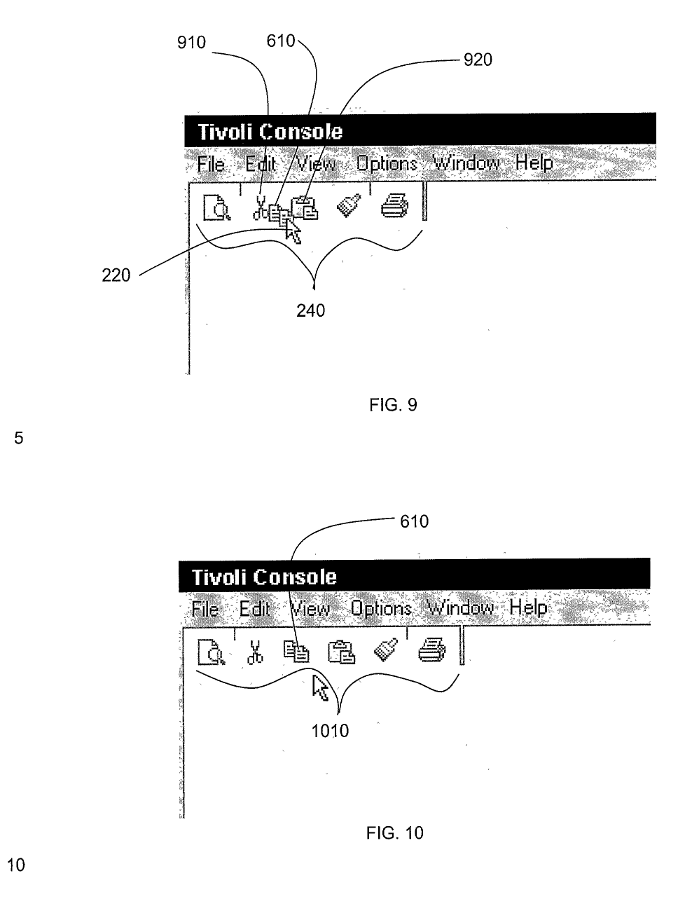

For one embodiment of the invention, a method for relocation of the duplicated icon and the icons associated function is referenced by the flow chart of FIG. 8 and illustrated in FIG. 9 and 10. In the embodiment illustrated by FIG. 9, the client chose a new toolbar 240 in which to place the double page “copy” icon 610 by placing the icon dragging cursor over the selected toolbar 240 (Block 810). If the toolbar is of a type that is hidden (Block 820), holding the cursor over the toolbars icon opens the toolbar for display (Block 830). The client can choose which location among the toolbar icons is the most preferred and in this embodiment, placement between the cut (scissors) 910 and paste (clip board) 920 functions is selected (Block 840). The cursor 220 carrying the copy icon 610 holds over the selected location (Block 850) and releases the icon in a manner known in the art (Block 860). The icon is inserted as a new item within the toolbar (Block 870) and the cursor returns to its normal appearance (Block 880). If the icon is released for insertion in a location that is not available as a toolbar or acceptable application, the cursor returns to its normal appearance (Block 880) and the association to the function is lost. FIG. 10 illustrates the copy icon 610 in its new location of custom toolbar 1010.

The above mentioned actions and like procedures can be created using JAVA, C, C++, HTML, LISP, or other programming languages known in the art. The present invention may be embodied in other specific forms without departing from its spirit or essential characteristics. The described embodiments are to be considered in all respects only as illustrative and not restrictive.

We claim:

1. A method for customizing a computer program resident toolbar comprising:
selecting at least one function available from the computer program;
assigning a pointer to the selected function, while the computer program remains fully operational; and
positioning the pointer to a desired location on the toolbar.

2. The method of claim 1 further comprising: loading a customization algorithm coinciding to the initial computer program execution.

3. The method of claim 1 wherein the at least one function is selected from a list of functions for the computer program.

4. The method of claim 3 wherein the list of functions for the computer program resides within a computer program toolbar.

5. The method of claim 1 further comprising: assigning the pointer to a selected function pointer.

6. The method of claim 1 wherein positioning the pointer to a desired location on a secondary toolbar is performed by a click and drag function.

7. The method of claim 1 wherein the selected function and the toolbar reside on different computer operating systems.

8. The method of claim 3 wherein the list of at least one function for the computer program is located on an alternative network.

9. The method of claim 3 wherein the list of at least one function for the computer program contains an icon.

10. The method of claim 9 wherein when the positioned pointer points to the icon, the pointer is represented as the icon on the toolbar.

11. The method of claim 3 wherein the list of functions for the computer program contain a command line.

12. The method of claim 11 wherein when the positioned pointer points to the command line, the pointer is represented as the icon on the toolbar.

13. The method of claim 1 wherein the desired location on the toolbar is located on an alternative computer program.

14. The method of claim 13 wherein the alternative computer program is located on a network.

15. The method of claim 1 wherein the selected function is positioned over features capable of receiving the selected functions operation.

16. The method of claim 15 wherein the features use the selected function as a resident function.

17. The method of claim 1 wherein moving the selected function icon from its list source graphically closes the list source.

18. A method for customizing a computer program resident toolbar comprising:
selecting at least one function available from the computer program;
copying a pointer to the selected function, while the computer program remains fully operational; and
positioning the copied pointer to a desired location on the toolbar.

19. A computer program product in a computer usable medium, comprising:
means for selecting at least one function available from the computer program;
means for assigning a pointer to the selected function, while the computer program remains fully operational; and
means for positioning the pointer to a desired location on the toolbar.

20. A computer program product in a computer usable medium, comprising:
means for selecting at least one function available from the computer program;
means for copying a pointer to the selected function, while the computer program remains fully operational; and
means for positioning the copied pointer to a desired location on the toolbar.
